(19) United States
(12) Patent Application Publication
(10) Pub. No.: US 2025/0037574 A1
(43) Pub. Date: Jan. 30, 2025

(54) Apparatus and Computer-Implemented Method for Moving a First Mobile Object at a Transportation Node and Mobile Object Comprising the Apparatus

(71) Applicant: Robert Bosch GmbH, Stuttgart (DE)

(72) Inventors: Felix Berkel, Schifferstadt (DE); Kevin Schmidt, Herrenberg (DE); Melanie Gallant, Kirchheim Unter Teck (DE); Sven Reimann, Renningen (DE)

(21) Appl. No.: 18/781,802

(22) Filed: Jul. 23, 2024

(30) Foreign Application Priority Data
Jul. 24, 2023 (DE) 10 2023 207 011.1

(51) Int. Cl. G08G 1/01

(52) U.S. Cl. CPC G08G 1/0112; G08G 1/0125

(57) ABSTRACT

A computer-implemented method for moving a first mobile object at a traffic node includes determining a state of the first mobile object including a position, a velocity, or an acceleration of the first mobile object, and receiving a trajectory of a state of a second mobile object at the traffic node. The method further includes determining a constraint for the state of the first mobile object based on the received trajectory of the state of the second mobile object, and determining a trajectory of the state of the first mobile object based on the state of the first mobile object using a model configured to predict the trajectory of the state of the first mobile object based on (i) a trajectory of a driving signal for moving the first mobile object, and (ii) the state of the first mobile object.

This application claims priority under 35 U.S.C. § 119 to patent application no. DE 10 2023 207 011.1, filed on Jul. 24, 2023 in Germany, the disclosure of which is incorporated herein by reference in its entirety.

### BACKGROUND

The disclosure is based on a device and a computer-implemented method for moving a first mobile object at a traffic junction and a mobile object comprising the device. Model predictive control of objects uses optimizers to determine trajectories for moving the objects.

### SUMMARY

The apparatus and the computer-implemented method for moving a first mobile object at a traffic node according to the disclosure optimizes a movement of the first mobile object at the traffic node. The procedure does not rely on an optimizer to function in order to avoid a collision with another object.

The computer-implemented method comprising determining a state of the first mobile object comprising a position, a velocity or an acceleration of the first mobile object, wherein a trajectory of a state of a second mobile object at the traffic node comprising a position, a velocity or an acceleration of the second mobile object is received, wherein a constraint for the state of the first mobile object is determined depending on the trajectory of the state of the second mobile object, wherein a model adapted to predict a trajectory of the state of the first mobile object depending on a trajectory of a driving signal for moving the first mobile object and depending on the state of the first mobile object is used to predict the trajectory of the state of the second mobile object, the trajectory of the state of the first mobile object is determined based on the state of the first mobile object, wherein the trajectory of the driving signal and the trajectory of the state of the first mobile object are determined within the constraint for the state of the first mobile object based on a cost function, wherein the cost function defines a target for the movement of the first mobile object with the trajectory of the driving signal on the trajectory of the state of the first mobile object, wherein the first mobile object is moved at the traffic node with a driving signal from the trajectory of the driving signal.

In one embodiment, a constraint for the actuation signal for the first mobile object is provided, wherein the driving signal is determined within the constraint for the driving signal.

In one embodiment, a target state is predetermined at the end of the trajectory of the state of the first mobile object, wherein the trajectory of the state of the first mobile object comprising the target state at the end of the trajectory is determined. In one embodiment, an allowable set is predetermined for a state at the end of the trajectory of the state of the first mobile object, wherein the trajectory of the state of the first mobile object is determined at which the state at the end of an optimization horizon lies within the allowable set.

It may be provided that a disturbance variable for the state of the second mobile object is received, with the restriction for the state of the first mobile object being determined as a function of the disturbance variable for the state of the second mobile object. This means that uncertainties occurring in the real world regarding the trajectory of the state of the second mobile object are also taken into account. This prevents a collision due to disturbances occurring in the real world with regard to the trajectory of the state of the second mobile object.

It may be provided that the model comprises a disturbance variable for the state of the first mobile object. This means that uncertainties in relation to an ideal model of the first mobile object are also taken into account. This prevents a collision even if the trajectory of the state of the first mobile object is disturbed in the real world.

In one embodiment, a sequence in which the first mobile object and the second mobile object are to be moved to the traffic node is predetermined, wherein the trajectory of the state of the first mobile object that complies with the sequence is determined.

In one embodiment, the trajectory of the state of the first mobile object is determined as a function of the trajectories of the states of mobile objects located in a predetermined area around the traffic node. This means that the procedure takes into account all mobile objects in the specified area together.

In one embodiment, the first mobile object and the second mobile object move along a lane in the same direction towards the traffic node without the presence of another mobile object between the first mobile object and the second mobile object. Optionally, a cooperative behavior of mobile objects moving one behind the other on the track can be achieved.

In one embodiment, the first mobile object and the second mobile object move towards the traffic junction on adjacent lanes in the same direction or on intersecting lanes at the traffic junction. Optionally, a cooperative behavior of moving mobile objects arriving one after the other at the traffic junction can be achieved.

The device for moving the first mobile object is designed to carry out the procedure. The device has advantages that correspond to those of the method.

A mobile object comprising the device has corresponding advantages.

A computer program comprising instructions executable by a computer, the execution of which by the computer executes the method, has advantages corresponding to the advantages of the method.

### BRIEF DESCRIPTION OF THE DRAWINGS

Further advantageous embodiments will become apparent from the following description and the drawing. The drawings show:

FIG. 1 a schematic representation of a mobile object with a device for moving the mobile object,

FIG. 2 a schematic representation of an exemplary traffic junction with mobile objects,

FIG. 3 a flow chart with steps of a method for moving a mobile object,

FIG. 4 a threading process according to a first embodiment,

FIG. 5 a threading process according to a second embodiment.

### DETAILED DESCRIPTION

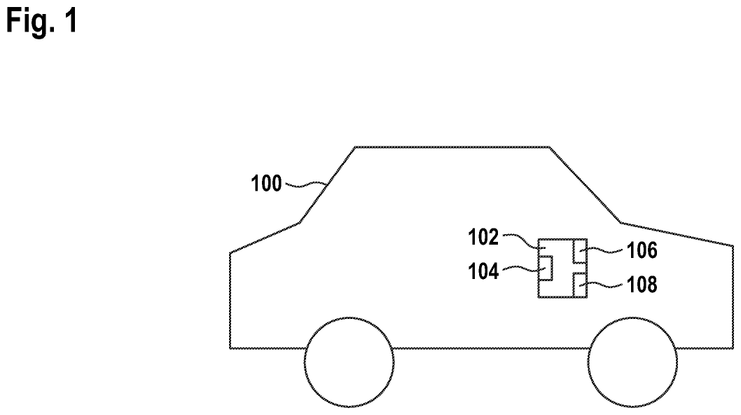

FIG. 1 shows a schematic representation of a mobile object 100 with a device 102 for moving the mobile object 100.

The device 102 is configured to perform a method for moving the mobile object 100.

In the example, the device 102 comprises a computing device 104, in particular at least one processor and at least one memory, which is designed to execute the method.

The device 102 comprises a receiver 106 configured to communicate with other mobile objects 100. The device 102 comprises an actuator 108 configured for driving the mobile object 100 to move the mobile object 100.

The mobile object 100 is a technical system. The technical system is a physical system, e.g., a mobile robot, in particular an at least partially autonomous vehicle, aircraft or ship. The vehicle can be an automobile or a transport vehicle of an industrial plant, e.g., a production plant.

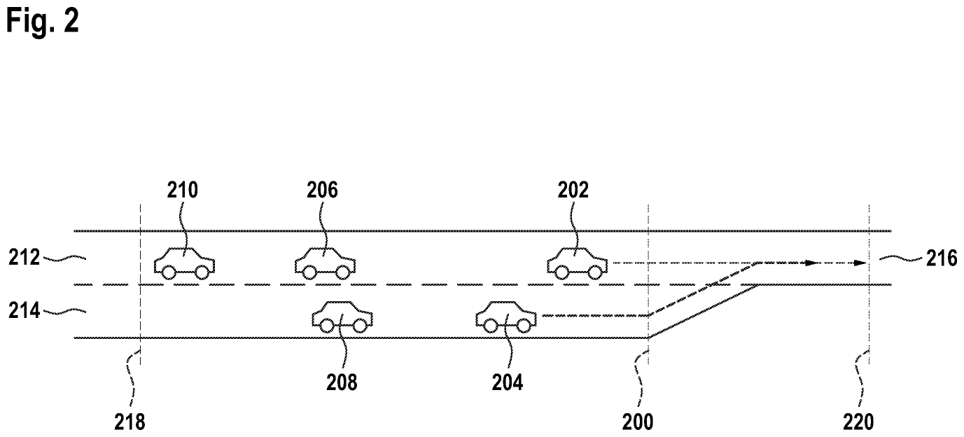

FIG. 2 shows a schematic representation of an exemplary traffic junction 200 with mobile objects.

In the example, a first vehicle 202, a second vehicle 204, a third vehicle 206, a fourth vehicle 208 and a fifth vehicle 210 are shown as mobile objects. The first vehicle 202, the third vehicle 206 and the fifth vehicle 210 move in this order along a first lane 212 towards the traffic junction 200. No other vehicle is arranged between the first vehicle 202, the third vehicle 206 and the fifth vehicle 210.

The second vehicle 204 and the fourth vehicle 208 move in this order on a second lane 214, which runs parallel to the first lane 212, towards the traffic junction 200. No other vehicle is arranged between the second vehicle 204 and the fourth vehicle 208.

In the example, the parallel lanes taper to a shared lane 216 at junction 202. The vehicles are located in an area around traffic junction 200. In the example, the area begins at an entrance 218 in the direction of movement of the vehicles before the traffic junction 200 and ends at an exit 220 in the direction of movement of the vehicles after the traffic junction 200.

Instead of parallel lanes, junction 200 can also include an intersection of the two lanes.

The vehicles are examples of mobile objects 100. In the example, the vehicles each comprise a device 102.

The devices 102 are configured to communicate with each other and to execute respective parts of a decentralized networked control and/or regulation method for a traffic node management.

The aim of transportation hub management can be to improve safety, throughput, energy efficiency and comfort.

The traffic node is designed without a central entity that receives information from all vehicles in order to solve the control problem centrally and then control the vehicles accordingly. The control problem is solved in a distributed manner on the individual vehicles. This saves costs or makes it possible to provide the corresponding function at remote nodes without a power supply in the first place. The device 100 is, for example, a control unit that is installed in the respective vehicle.

The traffic node 200 can be located in a warehouse, a production hall, an airport or a port.

The method is described using the example of controlling autonomous vehicles as part of a cooperative merging process at traffic junction 200, whereby the vehicles merge in a predefined sequence.

In the example, the sequence is defined by the time at which a vehicle enters entrance 218 of the area. The order can also be determined by a different procedure.

The first vehicle 202 passed the entrance 218 first in the example, followed in this order by the second vehicle 204, the third vehicle 206, the fourth vehicle 208 and the fifth vehicle 210.

On the one hand, the example is about realizing the threading process efficiently. This can mean, for example, that a good throughput of vehicles through the traffic junction 200 should be realized or that the threading process should be implemented in an energy-efficient manner. The target or targets are described mathematically using a cost function. The cost function is considered in the example in an optimization problem.

In the example, it is intended to comply with physical limits on speed or acceleration and to avoid collisions between vehicles.

The speed and acceleration of vehicles are limited, for example, by restrictions.

The constraints are, for example, constraints for a velocity vᵢ or an acceleration uᵢ of a vehicle i for the optimization problem:

$${v}_{min} \leq {v}_{i} \leq {v}_{max}$$

$${u}_{min} \leq {u}_{i} \leq {u}_{max}$$

In the example, a minimum distance dₘᵢₙ is specified for vehicles in the same lane. The minimum distance dₘᵢₙ between a position sᵢ(k) of a vehicle i at a calculated time k on the trajectory for this vehicle and a position sᵢ−(k) of a vehicle ahead of the vehicle at the calculated time k defines, for example, the constraint

$${s}_{i -} ( k ) - {s}_{i} ( k ) \geq {d}_{min}$$

The minimum distance dₘᵢₙ between a position sᵢ(k) of a vehicle i at a calculated time k on the trajectory for this vehicle and a position sᵢ+(k) of a vehicle following the vehicle at the calculated time k defines, for example, the constraint

$${s}_{i} ( k ) - {s}_{i +} ( k ) \geq {d}_{min}$$

In the example, the minimum distance dₘᵢₙ for vehicles in different lanes is only to be observed from junction 200, i.e., the threading point. The secondary conditions are e.g., for the threading point sₘ:

$${s}_{i -} ( k ) - {s}_{i} ( k ) \geq \{ \begin{matrix}{d}_{min} , & if {s}_{i -} ( k ) \geq {s}_{m} \\ - ∞ , & otherwise\end{matrix}$$

$${s}_{i} ( k ) - {s}_{i +} ( k ) \geq \{ \begin{matrix}{d}_{min} , & if {s}_{i} ( k ) \geq {s}_{m} \\ - ∞ , & otherwise\end{matrix}$$

If there is no threading point, e.g., at an intersection, it may be necessary to provide no minimum distance for vehicles in different lanes.

The vehicles move along trajectories of a state of the respective vehicle. The status of a vehicle is defined, for example, by its position, speed or acceleration.

In the example, the trajectories of the respective vehicles are determined in such a way that a cost function defined for each vehicle is minimized, the physical limit defined for each vehicle or the physical limits defined for each vehicle are observed and the vehicles do not collide. In this context, two vehicles do not collide, for example, if their respective positions are not identical at the same time.

In the example, one driving signal is determined for each vehicle. In the example, the driving signal is the acceleration.

In the example, model predictive control is used to determine the driving signal.

For example, measurements are taken in the vehicle at a time tₖ. These can be measurement signals from your own vehicle or measurement signals received from other vehicles or predicted trajectories.

Based on these measurements, a dynamic optimization problem is solved for each vehicle, whereby a trajectory of the state [xₖ, x₍ₖ₊₁₎, x₍ₖ₊₂₎, . . . ] in the example a position of the vehicle, over a

prediction horizon N is optimized taking into account the cost function.

The driving signal [uₖ, u₍ₖ₊₁₎, u₍ₖ₊₂₎, . . . ], in the example a target acceleration, is also optimized for the vehicle in order to realize the trajectory of the state. This is based on a dynamic model of the vehicle, which describes the relationship between the driving signal, e.g., the acceleration, and the status, e.g., the position of the vehicle.

Constraints may also be taken into account in the optimization problem. This limits the acceleration and braking capacity of a vehicle, which can be explicitly taken into account in the optimization. In the threading process, freedom from collision is important, which is taken into account in the cost function, e.g., through state restrictions. During optimization, this ensures that the trajectory of the position of the vehicle on which the optimization is being performed does not collide with any received trajectory of the position of a neighboring vehicle.

In practice, uncertainties occur due to model uncertainties or disturbances, so that the real trajectory of the state of a vehicle does not necessarily match the predicted trajectory of the state from the optimization problem.

In the example, only a first driving signal uₖ from the trajectory of the driving signal determined at a time t is applied to the vehicle. At time tₖ₊1, new measurements are recorded or the optimized trajectories are sent between the vehicles and the optimization problem is solved again with the current information and the first signal uₖ of the new trajectory of the driving signal is applied to the vehicle.

The cost function is defined, for example, by the following function, where q(x, u) and Q(x, u) define one or more of the stated targets:

$$J ( x ( \cdot \vert k ) , u ( \cdot \vert k ) ) = Q ( x ( k + N \vert k ) ) + {\sum }_{l = k}^{k + N - 1} q ( x ( l \vert k ) , u ( l \vert k ) )$$

An exemplary optimization problem is a minimization of the cost function:

$${min}_{u ( \cdot \vert k )} J ( x ( \cdot \vert k ) , u ( \cdot \vert k ) )$$

using a difference equation of a dynamic model of the vehicle

$$x ( l + 1 \vert k ) = Ax ( l \vert k ) + Bu ( l \vert k )$$

and the measurements of the state, in particular as a vector

$$x ( k \vert k ) = {x}_{meas} ( k )$$

and using one or more of the limitations

$$u ( l \vert k ) ∈ U$$

$$x ( l \vert k ) ∈ X$$

and, for example, using the terminal set condition for model predictive control

$$x ( k + N \vert k ) ∈ {Z}_{f} ( k )$$

In the example, the optimization problem is solved in the time steps k in the respective autonomous vehicle. For the state x(l|k) or the input u(l|k), k specifies the time step at which the optimization problem is solved and l specifies the time step within the prediction horizon N over which optimization takes place.

The difference equation represents a model in which the dynamic behavior of the vehicle is modeled, e.g., with a double integrator, i.e., with

$$\dot{s} = v$$

$$\dot{v} = a$$

where s represents the position, v the speed and a the acceleration of the vehicle.

The difference equation is determined by discretizing with the sampling time tₛ and the definition of the state vector x=[s v]^{T} and the input u=a.

The measurement x(k|k) of the state is a constraint that re-initializes the dynamic model with the current measurement at time step k in order to solve the optimization problem.

The restriction u(l|k)∈U is a secondary condition that takes into account the braking and/or acceleration capacity of the vehicle. The constraint x(l|k)∈X is a constraint that includes speed restrictions on the one hand. On the other hand, position restrictions can be taken into account here, whereby the limits of the position depend on the trajectories of the other vehicles involved in the threading process, for example.

In the example, an optimization in time step k for each vehicle i uses the respective optimized trajectory x*ⱼ(⋅,⋅) of the other vehicles j that have calculated it in time step k or k−1. In the example, the optimized trajectories x*ⱼ(⋅,⋅) of the vehicles are used if they have calculated in time step k that they will merge earlier, or if they have calculated in time step k−1 that they will merge later than vehicle i.

It is possible that a guarantee of freedom from collision will be provided. For this purpose, it is intended that the optimization problem can be solved in every time step k and thus all constraints describing the collision-free solution are fulfilled. To ensure solvability at each time step k, the concept of recursive feasibility is used, for example. The recursive solvability in the example is guaranteed by the introduction of the additional final state constraint for the final state in the prediction horizon. The end state constraint is a condition for a target state at the end of the trajectory of the state. The final state constraint is a condition for a permissible quantity for a state at the end of the trajectory of the state.

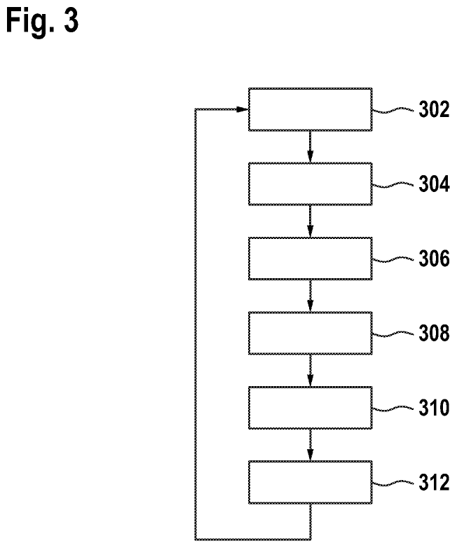

FIG. 3 shows a flowchart with steps of a procedure for moving the mobile object at a traffic junction. The method is described using the example of a first mobile object and a second mobile object.

The method is applied, for example, to the first mobile object and the second mobile object moving in the same direction on adjacent tracks.

The method is applied, for example, to the first mobile object and the second mobile object, which move towards the traffic junction on lanes that cross at the traffic junction.

The procedure is used accordingly for a number of mobile objects.

The method uses a model which is adapted to predict a trajectory [x(k+1), . . . , x(k+N)] of a state x of the first mobile object depending on a trajectory [u(k), u(k+1), . . . , u(k+N−1)] of a driving signal for moving the first mobile object and depending on the state x(k) of the first mobile object at time k. For example, the model includes the difference equation. For example, the driving signal is the acceleration of the first mobile object.

In a step 302, a state x(k) of the first mobile object is determined. The state x(k) refers to a point in time k. In the example, the state comprises a position s (k) and a speed v (k) of the first mobile object. The state x(k) can also include an acceleration of the first mobile object.

In a step 304, a trajectory [x*(k), x*(k+1), . . . x*(k+N)] of a state x*(k) of the second mobile object is received up to the prediction horizon N. In the example, the state x*(k) of the second mobile object comprises a position and a speed of the second mobile object. It may be provided that the state x*(k) comprises an acceleration of the second mobile object.

Optionally, it can be provided that a disturbance variable is received for the state of the second mobile object.

In the example, a predefined sequence in which the first mobile object and the second mobile object are to move through the traffic node is defined.

In a step 306, a constraint for the state of the first mobile object is determined depending on the trajectory of the state of the second mobile object.

Optionally, it can be provided that the restriction for the state of the first mobile object is determined as a function of the disturbance variable for the state of the second mobile object.

It may be provided that a restriction is specified for the driving signal for the first mobile object. For example, the acceleration limit is specified.

It may be provided that a target state at the end of the trajectory of the state of the first mobile object or a permissible quantity for a state at the end of the trajectory of the state of the first mobile object is specified. For example, the terminal set condition is specified.

In a step 308, the model is used to determine the trajectory [x(k+1), . . . , x(k+N)] of the state of the first mobile object based on the state x(k) of the first mobile object.

The trajectory [u(k), u(k+1), . . . , u(k+N−1)] of the driving signal and the trajectory [x(k+1), . . . , x(k+N)] of the state of the first mobile object are determined within the constraint for the state of the first mobile object depending on the cost function.

In the example, the trajectory of the state of the first mobile object that complies with the sequence is determined.

It may be provided that the driving signal is determined within the limitation for the driving signal.

It may be provided that the trajectory of the state of the first mobile object is determined in which the state at the end of the optimization horizon lies within an admissible set.

It may be provided that the model comprises a disturbance variable for the state of the first mobile object.

Optionally, it can be provided that the disturbance variable is determined for the state of the first mobile object.

The optimization problem is solved in the example with corresponding restrictions.

In a step 310, the trajectory [x(k+1), . . . , x(k+N)] of the state of the first mobile object is sent to the second mobile object.

Optionally, it can be provided that the disturbance variable for the state of the first mobile object is sent.

In a step 312, the first mobile object is moved with a driving signal from the trajectory [u(k), u(k+1), . . . , u(k+N−1)] of the driving signal.

In the example, the first mobile object is moved with the first driving signal u(k) from the trajectory [u(k), u(k+1), . . . , u(k+N−1)] of the driving signal.

Step 302 is then carried out.

For a plurality of vehicles, the trajectory of the state of the first mobile object is determined as a function of the trajectories of the states of the other mobile objects. In the example, the mobile objects located in the specified area around the traffic junction are taken into account.

The method is applied, for example, to the first mobile object and the second mobile object which are moving in the same direction towards the traffic junction in a lane between the first mobile object and the second mobile object without the presence of another mobile object.

The procedure is based on one or more of the following assumptions:
the participating vehicles are trained to move autonomously,
the participating vehicles are equipped with vehicle-to-vehicle (V2V) communication, which also allows the vehicles to be synchronized over time,
it is assumed that communication is error-free,
the participating vehicles know which other vehicles are the neighboring vehicles relevant for the threading process, with which the optimized trajectories are then exchanged via V2V communication,
the order in which the vehicles pass the traffic junction 200, i.e., the merging point sₘ, i.e., the merging sequence, is predetermined; the sequence does not change over time.

For example, the sequence is ensured via a FIFO (first-in-first-out) procedure with regard to the entry of vehicles into the area at entrance 218.

The following section looks at the threading process with M vehicles. The first vehicle in the threading sequence has the index i=0, and the last has the index i=M−1. In the example of the five vehicles, the first vehicle 202 in the threading sequence has the index i=0, the second vehicle 204 has the index i=1, the third vehicle 206 has the index i=2, the fourth vehicle 208 has the index i=3 and the fifth vehicle 210 has the index i=4. More or less than five vehicles can be considered.

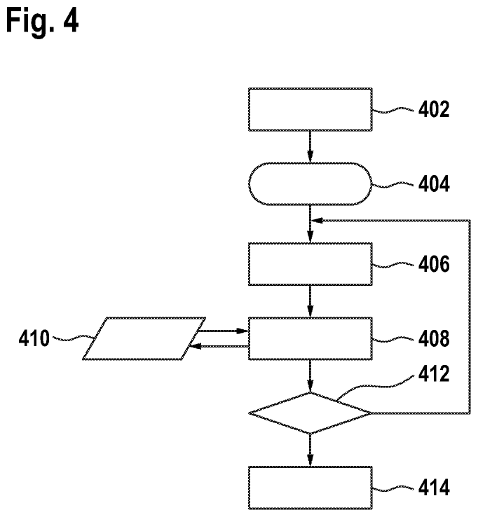

FIG. 4 shows a sequence of a threading process according to a first embodiment in which no uncertainties are taken into account. In the threading process according to the first embodiment, cooperative behavior between the vehicles is not assumed.

The steps of the threading process according to the first embodiment are described below. The procedure for moving the mobile object runs in the example on the respective participating vehicles and provides a safety guarantee that there will be no collisions.

The steps of the threading process according to the first embodiment shown in FIG. 4 are carried out in the participating vehicles during the threading process, i.e., while the respective vehicle is located between the entrance 218 and the exit 220 of the area, in each case at a time k.

### Step 402:

In step 402, the state x; (k) of the respective vehicle is recorded in the participating vehicles at time k. In the example, measurement data is recorded that characterizes the status, e.g., an acceleration, a speed or a position of the respective vehicle.

### Step 404:

In step 404, a variable i for identifying the participating vehicles is initialized to zero.

### Step 406:

In step 406, a terminal set Z_{f,i} assigned to each participating vehicle i is updated.

One terminal set Z_{f,i} is provided for each participating vehicle. In the example, the terminal set Z_{f,i} is determined for a participating vehicle using conventional optimization. The terminal sets of the participating vehicles are calculated offline, for example.

In the example, one fault coordinate system is used for each participating vehicle i. In the fault coordinate system of the respective vehicle i, it is set according to the specified sequence in relation to the vehicle immediately ahead of it and M subsystems Eᵢ are defined, which describe fault dynamics by means of fault states.

The error state z₀ for the first vehicle i=0 is

$${z}_{0} ( k ) = ( \begin{matrix}{s}_{0} ( k ) - {s}_{ref} ( k ) \\ {v}_{0} ( k ) - {v}_{ref}\end{matrix} ) = : ( \begin{matrix}{{s}^{′}}_{0} ( k ) \\ {{v}^{′}}_{0} ( k )\end{matrix} )$$

wherein v_{ref} is the reference speed, s_{ref}(k)=ktₛv_{ref} is the reference position of the first vehicle at time k, v₀(k) is the speed of the first vehicle at time k and tₛ is the sampling time. In the example, the first vehicle has no vehicle in front of it. In the example, the first vehicle is assumed to be controlled to a specified reference speed v_{ref} and a fault state z₀(k) of the first vehicle is determined as a function of its initial position s₀(k) and its initial speed v₀(k) and a time tₛ.

The error status zᵢ is determined for the other participating vehicles:

$${z}_{i} ( k ) = ( \begin{matrix}{s}_{i - 1} ( k ) - {s}_{i} ( k ) - {d}_{ref} \\ {v}_{i} ( k ) - {v}_{ref}\end{matrix} ) = : ( \begin{matrix}{{d}^{′}}_{i} ( k ) \\ {{v}^{′}}_{i} ( k )\end{matrix} ) , i = 1 , ... , M - 1$$

The error state zᵢ contains a distance error to the vehicle i−1 immediately ahead according to the sequence and a speed error vᵢ(k)−v_{ref} in relation to the reference speed v_{ref}. In the example, a common reference speed is used for the participating vehicles so that the participating vehicles are synchronized in speed. In the example, a reference distance d_{ref}=dₘᵢₙ+t_{d}v_{ref} is defined, where td is a specified time interval. Based on these fault state definitions, a terminal set Z_{f,i} is calculated, which is defined as an ellipsoid around the origin of the fault coordinate system. One way to do this is described in Christian Conte et al. “Distributed synthesis and stability of cooperative distributed model predictive control for linear systems”. in: Automatica 69 (2016).

### Step 408:

In step 408, the optimization problem is solved for each participating vehicle i.

The solution of the optimization problem comprises an optimized trajectory x*ᵢ for each participating vehicle up to the prediction horizon N. The respective final state at the end of the prediction horizon N lies in the terminal set Z_{f,i}.

In the example, the following cost function is defined for the optimization problem:

$${J}_{i} ( {x}_{i} ( k ) , {u}_{i} ( k : k + N - 1 \vert k ) ) = {\sum }_{l = k}^{k + N - 1} [ ρ ( {{ρ}_{n , i} ( l )}^{2} + {{ρ}_{o , i} ( l )}^{2} ) + {q ( {v}_{i} ( l \vert k ) - {v}_{ref} )}^{2} + {{ru}_{i} ( l \vert k )}^{2} ] + p ( {{ρ}_{n , i} ( N )}^{2} + {{ρ}_{o , i} ( N )}^{2} ) + {q ( {v}_{i} ( k + N \vert k ) - {v}_{ref} )}^{2}$$

where in the cost function a deviation of the speed of the respective participating vehicle from the reference speed (vᵢ(l|k)−v_{ref})² and a manipulated variable cost uᵢ(l|k)² for the driving signal of the respective vehicle is penalized as a secondary condition. These two terms can be weighted by weighting factors q and r respectively.

In the example, the cost function includes slack variables ρ_{n,i} and ρ_{o,i}, which make it possible to relax the constraint. The slip variables are optional.

An exemplary optimization problem for a vehicle i is:

$${min}_{{u}_{i} ( \cdot \vert k )} {J}_{i} ( {x}_{i} ( k ) , {u}_{i} ( k : k + N - 1 \vert k ) )$$

To solve the optimization problem, the information from the other participating vehicles is used, which is transmitted through the communication. This information is the optimized trajectories x*_{Ni} of the other participating vehicles, which are optimized in these.

In the example, the cost function is to be minimized under secondary conditions. In the example, the constraints include the discrete-time system dynamics of the vehicle

$${x}_{i} ( l + 1 \vert k ) = {A}_{i} {x}_{i} ( l \vert k ) + {B}_{i} {u}_{i} ( l \vert k ) , l = k , ... , k + N - 1$$

with the initial state xᵢ(k|k) from the measurement.
In the example, the constraints include acceleration limits uₘᵢₙ≤uᵢ(l|k)≤uₘₐₓ, l=k, . . . , k+N−1 and speed limits vₘᵢₙ≤vᵢ(l|k)≤vₘₐₓ, l=k, . . . , k+N of the vehicle.

The secondary conditions include distance conditions

$${s}_{{n}_{i} -}^{*} ( l \vert k ) - {s}_{i} ( l \vert k ) \geq {d}_{min} + {t}_{d} {v}_{i} ( l \vert k ) - {ρ}_{n , i} ( l ) , l = k , ... , k + N$$

$$and$$

$${ρ}_{n , i} ( l ) \leq {t}_{d} {v}_{i} ( l \vert k ) , l = k , ... , k + N$$

to the vehicle in front nᵢ− in the same lane.

These two conditions ensure that the minimum distance dₘᵢₙ is maintained.

If the slip variable ρ_{n,i} becomes very small, the speed-dependent distance t_{d}vᵢ(l|k) is maintained in addition to the minimum distance.

This results from solving the optimization problem, since ρ_{n,i} is taken into account in the cost function, and thus depends on the weighting p of the slack variables.

The secondary conditions include a distance condition

$${s}_{i} ( l \vert k ) - {s}_{{n}_{i} +}^{*} ( l \vert k - 1 ) \geq {d}_{min} , l = k , ... , k + N - 1$$

to the vehicle behind nᵢ+ in the same lane.

The secondary conditions include distance conditions

$${s}_{{o}_{i} -}^{*} ( l \vert k ) - {s}_{i} ( l \vert k ) \geq \{ \begin{matrix}{d}_{min} + {t}_{d} {v}_{i} ( l \vert k ) - {ρ}_{o , i} ( l ) , & if {s}_{{o}_{i} -}^{*} ( l \vert k ) \geq {s}_{m} \\ - ∞ , & otherwise\end{matrix} , l = k , ... , k + N$$

$${ρ}_{o , i} ( l ) \leq {t}_{d} {v}_{i} ( l \vert k ) , l = k , ... , k + N$$

$${s}_{i} ( l \vert k ) \leq \{ \begin{matrix}{s}_{m} - {d}_{min} , & if {s}_{{o}_{i -}}^{*} ( l \vert k ) \leq {s}_{m} \\ ∞ , & otherwise\end{matrix} , l = k , ... , k + N$$

to the vehicle in front oᵢ− in the lane parallel to the lane of the vehicle. With the same motivation, a final variable ρ_{o,i} is introduced here, which is also taken into account in the cost function. These distance conditions only apply from the sₘ threading point. The last of these distance conditions is introduced to ensure recursive solvability.

The secondary conditions include a distance condition

$${s}_{i} ( l \vert k ) - {s}_{{o}_{i} +}^{*} ( l \vert k - 1 ) \geq \{ \begin{matrix}{d}_{min} , & if {s}_{{o}_{i +}}^{*} ( l \vert k - 1 ) > {s}_{m} - {d}_{min} \\ - ∞ , & otherwise\end{matrix} , l = k , ... , k + N - 1$$

to the vehicle behind oᵢ+ in the lane parallel to the vehicle's lane.

The secondary conditions include conditions for the final position and the final speed of the vehicle

$${z}_{i} ( k + N \vert k ) = ( \begin{matrix}{s}_{{o}_{i} -}^{*} ( k + N \vert k ) - {s}_{i} ( k + N \vert k ) - {d}_{ref} \\ {v}_{i} ( k + N \vert k ) - {v}_{ref}\end{matrix} ) ∈ {Z}_{f , i} ( k ) , \\ i = 1 , ... , M - 1$$

$${z}_{i} ( k + N - 1 \vert k ) = ( \begin{matrix}{s}_{{o}_{i} -}^{*} ( k + N - 1 \vert k ) - {s}_{i} ( k + N - 1 \vert k ) - {d}_{ref} \\ {v}_{i} ( k + N - 1 \vert k ) - {v}_{ref}\end{matrix} ) ∈ {Z}_{f , i} ( k - 1 ) , i = 1 , ... , M - 1$$

$${z}_{i} ( k + N \vert k ) = ( \begin{matrix}{s}_{i} ( k + N \vert k ) - {s}_{ref} ( k + N ) \\ {v}_{i} ( k + N \vert k ) - {v}_{ref}\end{matrix} ) ∈ {Z}_{f , i} ( k ) , i = 0$$

$${z}_{i} ( k + N - 1 \vert k ) = ( \begin{matrix}{s}_{i} ( k + N - 1 \vert k ) - {s}_{ref} ( k + N - 1 ) \\ {v}_{i} ( k + N - 1 \vert k ) - {v}_{ref}\end{matrix} ) ∈ {Z}_{f , i} ( k - 1 ) , i = 0$$

and a condition to ensure recursive solvability:

$${z}_{i + 1} ( k + N - 1 \vert k ) = ( \begin{matrix}{s}_{i} ( k + N - 1 \vert k ) - {s}_{{o}_{i} +}^{*} ( k + N - 1 \vert k - 1 ) - {d}_{ref} \\ {v}_{{o}_{i} +}^{*} ( k + N - 1 \vert k - 1 ) - {v}_{ref}\end{matrix} ) ∈ {Z}_{f , i + 1} ( k - 1 )$$

### Step 410:

In step 410, the optimized trajectories x*_{Ni} are exchanged between the participating vehicles.

### Step 412:

Step 412 checks whether steps 408 and 410 have been carried out for the M participating vehicles. For example, it is checked whether the variable i=M−1.

When steps 408 and 410 have been performed for the M participating vehicles, a step 414 is performed. Otherwise, the steps for the next vehicle are carried out in sequence. For example, the variable i is assigned the value i+1.

In step 414, the participating vehicles are controlled with the driving signal.

In the example, the first value of the optimized trajectory of the driving signal u(k), in the example the acceleration in the vehicle, is applied for each vehicle. This means that the required acceleration is regulated by a subordinate acceleration controller in each vehicle involved in the threading process.

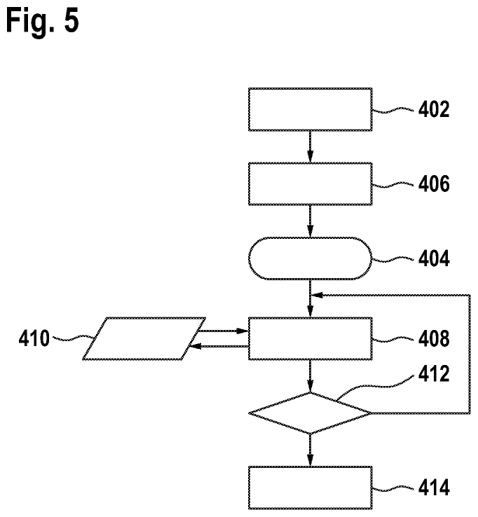

FIG. 5 shows a sequence of the threading process according to a second embodiment in which uncertainties are taken into account.

To take the uncertainties into account, the model with the optimum deterministic input signal is extended by a disturbance variable input, i.e.,

$${x}_{i} ( k + 1 ) = {A}_{i} {x}_{i} ( k ) + {B}_{i} {u}_{i} ( k ) + {D}_{i} {w}_{i} ( k )$$

The disturbance variable wᵢ is generally unknown and therefore not measurable, but it is assumed that the limits of the disturbance are known, for example in the following form:

$${W}_{i} = \{ {w}_{i} ∈ {ℝ}^{{n}_{{w}_{i}} \times 1} \vert {‖ {w}_{i} ‖}_{∞} \leq {w}_{i , max} \}$$

Such disturbances cause errors in the prediction of the trajectories. This can lead to the real trajectory sᵢ(l) deviating from the trajectory sᵢ*(l|k) predicted in the optimization problem. Therefore, the possible set of disturbance variables Wᵢ is now taken into account in the prediction of the trajectory, resulting in a set of possible trajectories.

It may be intended to model uncertainties in communication in the faults.

In the example, according to the second embodiment of interference uncertainties in step 410, no trajectories are communicated between the vehicles but contracts C_{Ni}, which describe the set of possible trajectories based on the optimal deterministic input signal.

In step 408, the optimization is determined with the model in which the optimal deterministic input signal is extended by the disturbance variable input. In the example, the same cost function is used as in the first embodiment.

In the example, the following control law is used instead of the difference equation:

$${x}_{i} ( l + 1 \vert k ) = ( {A}_{i} + {B}_{i} {K}_{w , i} ) {x}_{i} ( l \vert k ) + {B}_{i} {c}_{i} ( l \vert k ) , l = k , ... , k + N - 1$$

$${u}_{i} ( l \vert k ) = {c}_{i} ( l \vert k ) + {K}_{w , i} {x}_{i} ( l \vert k ) , , l = k , ... , k + N - 1$$

$${x}_{i} ( k \vert k ) = {x}_{i} ( k )$$

$${u}_{i} ( l \vert k ) ∈ {\overline{U}}_{i , l - k} , l = k , ... , k + N - 1$$

$${x}_{i} ( l \vert k ) ∈ {\overline{X}}_{i , l - k} ( {\underline{x}}_{{n}_{i} -}^{*} ( l \vert k ) , {\underline{x}}_{{o}_{i} -}^{*} ( l \vert k ) , {\overline{x}}_{{o}_{i} +}^{*} ( l \vert k - 1 ) , {\overline{x}}_{{n}_{i} +}^{*} ( l \vert k - 1 ) ) , \\ l = k , ... , k + N$$

$${z}_{i} ( k + N \vert K ) ∈ {Z}_{f , i} ( k )$$

$${z}_{i + 1} ( k + N \vert k ) ∈ {Z}_{f , i + 1} ( k )$$

$${z}_{i + 2} ( k + N \vert k ) ∈ {Z}_{f , i + 2} ( k )$$

This means that a state controller is added to the controller to compensate for the faults. The terminal sets of the optimization problem of the model predictive control are determined, for example, taking into account the uncertainties. The restrictions for the driving signal u and the state x are also adjusted taking into account the contracts C_{Ni}. An example of this can be found in Christian Conte et al. “Robust distributed model predictive control of linear systems”. in: 2013 European Control Conference (ECC). The other conditions are the secondary conditions relating to the terminal sets.

The contracts are exchanged between the vehicles in order to take account of the uncertainties in the optimization. These contracts contain, for example, a set of the predicted possible trajectories of the vehicles. In the example, the vehicles take into account the worst-case trajectory of the neighboring vehicles in their own optimization from the contracts received.

The remaining steps of the threading process according to the second embodiment are as described for the threading process according to the first embodiment, wherein the step 406 for updating the terminal set is performed in the example between the step 402 for determining the state xᵢ(k) of the respective vehicle and the step 404 for initializing the variable i for identifying the participating vehicles to zero.

During the threading process according to both embodiments, cooperative behavior between the vehicles can optionally be sought. This ensures, for example, that one of the participating vehicles accelerates for a vehicle merging behind it, so that the overall flow of traffic is improved.

For example, the cost function and the constraints in the optimization problem are adjusted for cooperation between the vehicles. For this purpose, slip variables ρₙ_{ᵢ}_{^{+ and ρ}}ₒ_{ᵢ}_{^{+ are introduced in relation to a vehicle driving behind a vehicle.}}

The conditions

$${s}_{i} ( l \vert k ) - {s}_{{n}_{i} +}^{*} ( l \vert k - 1 ) \geq {d}_{min} + {t}_{d} {v}_{{n}_{i} +}^{*} ( l \vert k - 1 ) - {ρ}_{{n}_{i} +} ( l ) , \\ l = k , ... , k + N - 1$$

$${ρ}_{{n}_{i} +} ( l ) \leq {t}_{d} {v}_{{n}_{i} +}^{*} ( l \vert k - 1 ) , l = k , ... , k + N - 1$$

replace the condition

$${s}_{i} ( l \vert k ) - {s}_{{n}_{i} +}^{*} ( l \vert k - 1 ) \geq {d}_{min} , l = k , ... , k + N - 1$$

in the optimization problem mentioned above.

The condition

$${s}_{i} ( l \vert k ) - {s}_{{o}_{i} +}^{*} ( l \vert k - 1 ) \geq \{ \begin{matrix}{d}_{min} , & if {s}_{{o}_{i +}}^{*} ( l \vert k - 1 ) > {s}_{m} - {d}_{min} \\ - ∞ , & otherwise\end{matrix} , l = k , ... , k + N - 1$$

will be replaced by the condition

$${s}_{i} ( l \vert k ) - {s}_{{o}_{i} +}^{*} ( l \vert k - 1 ) \geq \{ \begin{matrix}{d}_{min} + {t}_{d} {v}_{{o}_{i} +}^{*} ( l \vert k - 1 ) - {ρ}_{{o}_{i} +} ( l ) , & if {s}_{{o}_{i +}}^{*} ( l \vert k - 1 ) > {s}_{m} - {d}_{min} \\ - ∞ , & otherwise\end{matrix} , l = k , ... , k + N - 1$$

$${ρ}_{{o}_{i} +} ( l ) \leq {t}_{d} {v}_{{o}_{i} +}^{*} ( l \vert k - 1 ) , l = k , ... , k + N - 1$$

in the optimization problem mentioned above.

The cost function is extended by the slack variables:

$${J}_{{N}_{i}} ( {x}_{i} ( k ) , {u}_{i} ( k : k + N - 1 \vert k ) ) = {w}_{i} {J}_{i} ( {x}_{i} ( k ) , {u}_{i} ( k : k + N - 1 \vert k ) ) + {\sum }_{l = k}^{k + N - 1} ( {w}_{n} {{ρ}_{{n}_{i} +} ( l )}^{2} + {w}_{o} {{ρ}_{{o}_{i} +} ( l )}^{2} ) = {w}_{i} ( {\sum }_{l = k}^{k + N - 1} [ ρ ( {{ρ}_{n , i} ( l )}^{2} + {{ρ}_{o , i} ( l )}^{2} ) + {q ( {v}_{i} ( l \vert k ) - {v}_{ref} )}^{2} + {{ru}_{i} ( l \vert k )}^{2} ] + p ( {{ρ}_{n , i} ( N )}^{2} + {{ρ}_{o , i} ( N )}^{2} ) + {q ( {v}_{i} ( k + N \vert k ) - {v}_{ref} )}^{2} ) + {\sum }_{l = k}^{k + N - 1} ( {w}_{n} {{ρ}_{{n}_{i} +} ( l )}^{2} + {w}_{o} {{ρ}_{{o}_{i} +} ( l )}^{2} )$$

The cooperative behavior can then be influenced by the weightings wᵢ, wₙ and wₒ, whereby wₙ=0 and wₒ=0 can be used to stop cooperation with both vehicles behind. As explained here for the nominal case, the cooperative behavior can also be integrated into the robust case.

The described distributed cooperative control of moving objects at nodes is formulated in the example as model predictive control, whereby an optimization problem is solved repeatedly at runtime, taking into account the system dynamics of the vehicles. The absence of collisions is formulated and guaranteed in the form of secondary conditions, e.g., safety distance between the vehicles.

The vehicles involved are equipped with V2X technology for communication, for example. Communication takes place either directly or via a cloud/edge connection. It is possible for non-communicating vehicles to be taken into account as participating vehicles by recording their trajectory from another participating vehicle. However, the non-communicating vehicle is not controlled with a driving signal.

Overall, the advantages are as follows:

Model predictive control is an advantageous way of reacting to unforeseen behavior. Collision avoidance can be realized directly through restrictions and is ensured at all times.

The explicit consideration of disturbances makes it possible to extend the formal guarantees beyond the nominal model.

The solvability of the optimization problem as a function of the disturbances can also serve as a requirement or contract for subordinate control functions. For collision avoidance, there is a formal guarantee of compliance with the restrictions under the assumptions described.

The cost function can take very different criteria into account, e.g., throughput, energy efficiency, convenience.

By exchanging entire trajectories between the participating vehicles, the process is robust against typical communication problems such as packet failure and delays. In case of doubt, for example, the last transmitted trajectory of another subscriber or other subscribers will be used until a new one has been transmitted.

The consideration of uncertainties and disturbances in the design of the control function makes it possible to use the function as part of a safe-by-design approach. The total uncertainty tolerated by the function can be represented by the disturbance influence. Depending on the actual faults present, the control function can simply be adapted (more conservative/more performant).

The optional consideration of the other participants through the exchange of certain additional variables makes it possible to integrate cooperative behavior into the function without losing the formal guarantees of e.g., freedom from collision.

The safety guarantees apply because the optimization problem of the model predictive control is formulated in such a way that safety guarantees can be given. The constraints in the optimization problem are optionally specified in such a way that freedom from collision, e.g., during the threading process, can be guaranteed even taking the uncertainties into account. In addition, the recursive solvability of the optimization problem of the model predictive control is ensured, i.e., if the optimization problem can be solved in one step, it can also be solved in all further steps. This is particularly important when taking into account restrictions that are important for collision clearance.

What is claimed is:

1. A computer-implemented method for moving a first mobile object at a traffic node, comprising:
determining a state of the first mobile object including a position, a velocity, or an acceleration of the first mobile object;
receiving a trajectory of a state of a second mobile object at the traffic node, the state of the second mobile object including a position, a velocity, or an acceleration of the second mobile object;
determining a constraint for the state of the first mobile object based on the received trajectory of the state of the second mobile object;
determining a trajectory of the state of the first mobile object based on the state of the first mobile object using a model configured to predict the trajectory of the state of the first mobile object based on (i) a trajectory of a driving signal for moving the first mobile object, and (ii) the state of the first mobile object; and
determining the trajectory of the driving signal and the trajectory of the state of the first mobile object within the constraint for the state of the first mobile object as a function of a cost function,
wherein the cost function defines a destination for movement of the first mobile object with the trajectory of the driving signal on the trajectory of the state of the first mobile object, and
wherein the first mobile object is moved at the traffic node with the driving signal from the trajectory of the driving signal.

2. The method according to claim 1, further comprising:
predetermining a constraint for the driving signal for the first mobile object,
wherein the driving signal is determined within the constraint for the driving signal.

3. The method according to claim 1, wherein:
a target state at an end of the trajectory of the state of the first mobile object is predetermined, and the trajectory of the state of the first mobile object is determined, which comprises the target state at the end of the trajectory, or
an admissible quantity for a state at the end of the trajectory of the state of the first mobile object is predetermined, and the trajectory of the state of the first mobile object is determined, in which the state at the end of an optimization horizon lies in the admissible quantity.

4. The method according to claim 1, further comprising:
receiving one disturbance variable for the state of the second mobile object,
wherein the constraint for the state of the first mobile object is determined depending on the one disturbance variable for the state of the second mobile object.

5. The method according to claim 1, wherein the model comprises a disturbance variable for the state of the first mobile object.

6. The method according to claim 1, further comprising:
predetermining a sequence in which the first mobile object and the second mobile object are to be moved to the traffic node,
wherein the trajectory of the state of the first mobile object is determined, which maintains the sequence.

7. The method according to claim 1, further comprising;
determining the trajectory of the state of the first mobile object as a function of trajectories of states of mobile objects located in a predetermined area around the traffic node.

8. The method according to claim 1, wherein the first mobile object and the second mobile object move on a track in a same direction towards the traffic node without a presence of another mobile object between the first mobile object and the second mobile object.

9. The method according to claim 1, wherein the first mobile object and the second mobile object move on adjacent lanes in a same direction or on lanes intersecting at the traffic node towards the traffic node.

10. A device for moving a first mobile object at a traffic node according to the method of claim 1.

11. A mobile object comprising the device of claim 10.

12. The method according to claim 1, wherein a computer program comprises instructions which can be executed by a computer and during the execution of which by the computer the method is carried out.
